(19) United States
(12) Patent Application Publication
(10) Pub. No.: US 2010/0035114 A1
(43) Pub. Date: Feb. 11, 2010

(54) Silicon-based Nanostructured Diode Fuel Cell

(76) Inventor: Mark Anthony Rigoglioso, New York, NY (US)

Correspondence Address: Mark Rigoglioso, 1595 Mayflower Avenue #1, Bronx, NY, 10461, US

(21) Appl. No.: 12/187,533

(22) Filed: Aug. 7, 2008

(51) Int. Cl. H01M 8/10; H01M 4/86

(52) U.S. Cl. 429/33; 429/12; 429/40

(57) ABSTRACT

This design introduces a new paradigm for fuel cells, mimicking the action of a diode more than a battery, fundamentally changing fuel cell dynamics. This design addresses the major obstacles encountered in producing platinum-free fuel cells in a scalable format including the cost of catalytic materials, fuel flow control within the cell, power density, current regulation, voltage stability, contamination of electrode materials, water management and scalability.

This proposal shows that it is possible to construct a new type of fuel cell using known semi-conductor fabrication techniques combined with recent discoveries in nanoscale material fabrication. It is possible to produce a fuel cell that does not require expensive platinum or palladium in the electrodes to facilitate low temperature operation. Rather, much less expensive materials can be combined in such a way that their compounded effect mimics the catalytic effects of the former materials. The design outlined here pulls together the results of sophisticated but otherwise unrelated scientific research into a cohesive whole design for a new type of fuel cell heretofore unrealized.

This design will enable the fuel cell to compete with the internal combustion engine and surpass battery technology at all levels of scale in the near future. The result will be that every application requiring an internal combustion engine or a battery can be replaced by a fuel cell of appropriate size. This breakthrough will change the energy equation by allowing hydrogen to compete with conventional energy sources. Low cost, high power fuel cells will make large-scale hydrogen production from water utilizing wind and solar power immediately worthwhile. Hydrogen can eventually replace both conventionally generated electricity and petroleum-based fuels resulting in the development of large-scale renewable energy industries.

Given the limited quantities of petroleum, natural gas, coal and biomass on Earth, given the concerns of carbon dioxide pollution and given the demands of a growing world economy, a hydrogen energy industry driven by renewable energy must begin to compete with and eventually surpass fossil-fuel-generated energy. Hydrogen consumed in low cost fuel cells at high efficiency is the only viable long-term energy option for the future of an ordered, peaceful world.

### CROSS REFERENCE TO RELATED INVENTIONS

This design proposal references and is based upon the results of several published scientific papers, which are listed in the ‘Background of the Invention’. The outcome of these researches has not been, to my knowledge, submitted for patents neither as processes nor as any specific devices either individually or in any combination. I considered the outcomes of the research papers to have been published for public consumption intended to suggest ways of handling certain problems in materials engineering. If any of the research cited here has been submitted for patents or is under any other type of restriction, I hereby declare I am not aware of it and intend no plagiarism nor credit where it is not due.

### STATEMENT REGARDING FEDERALLY SPONSORED RESEARCH OR DEVELOPMENT

Not Applicable

### REFERENCE TO A SEQUENCE LISTING, A TABLE OR COMPACT DISK MATERIAL

Not Applicable

### BACKGROUND OF THE INVENTION

Hydrogen fuel cells are of great interest to us today because they hold the promise of portable generation of electricity on demand with high efficiency and very low to zero carbon emissions. While fuel cells have been around for over 150 years, it was in the 1960's that NASA engineers developed the modern, functioning fuel cell that we are most familiar with. The basic design of the fuel cell is comprised of two platinum-coated electrodes separated by a Teflon-based membrane called Nafion. Hydrogen introduced at one electrode is separated into protons, which travel through the Nafion, and electrons, which follow a separate path to produce electric current. The platinum catalyst allows the reaction to proceed at a relatively low temperature of 180 to 200 degrees F. The protons and electrons meet up at the other electrode where oxygen is introduced. The oxygen combines with the protons and electrons on the other electrode surface to produce water and heat. It is in fact the rate of the oxygen reaction that determines the level of current the fuel cell is capable of producing while fuel flow efficiency and hydration in large part determine the voltage level the cell can maintain.

While hydrogen fuel cells hold great promise, there are limitations due to the very high cost of platinum, water regulation within the fuel cell, power density, proton transport inefficiencies, slowness of oxygen reduction and electrode contamination, amongst other issues. Nafion, the electrolyte core material, must be hydrated to work properly and changes size dramatically as its water content varies. Nafion also transports hydrogen ions in a clustered and inefficient way determined by the random distribution of sulfonic acid groups (SO⁻H⁺) and water molecules embedded in its structure. (Raghav 2005). Conventional fuel cells rely on the random diffusion of gases through materials and have a power density limited by the surface area of conventional porous materials. While this value can be quite high, it is still a major factor limiting the performance of fuel cells.

Non-platinum fuel cells that operate at high temperatures and high efficiencies exist for industrial applications; but the start of a true hydrogen economy appears to be stalled by the lack of a low-cost, low temperature fuel cell for use in cars, trucks, electronic devices and similar non-industrial applications.

The following scientific research papers are cited in this patent proposal and constitute the basis for its integrity:

Silicon Nanotubes as a Promising Candidate for Hydrogen Storage: from the First Principle Calculations to Grand Canonical Monte Carlo Simulations
Jianhui Lan, Daojian Cheng, Dapeng Cao and Wenchuan Wang Division of Molecular and Materials Simulation, Key Lab for Nanomaterials, Ministry of Education, Beijing University of Chemical Technology, People's Republic of China Received: Dec. 14, 2007; In Final Form: Jan. 21, 2008
© 2008 American Chemical Society

### Fast Mass Transport Through Sub-2-Nanometer Carbon Nanotubes

Jason K. Holt, Hyung Gyu Park, Yimnin Wang, Michael Staderman, Alexander B. Artyukhin, Costas P. Grigoropoulos, Aleksandr Noy and Olgica Bakajin Chemical and Materials Science Directorate, Lawrence Livermore National Laboratory, Livermore, Calif. 94720, USA
Science Magazine, 19 May 2006, VOL. 312
© 2008 American Association for the Advancement of Science

### Gated Proton Transport in Aligned Mesoporous Silica Films

Rong Fan, Seong Huh, Ruoxue Yan, John Arnold and Peidong Yang Department of Chemistry; Department of Materials Science and Engineering, University of California; Materials Science Division, Lawrence Berkeley National Laboratory, Berkeley, Calif. 94720, USA
® 2008 Nature Publishing Group

### Vertically Aligned Single-Crystal ZnO Nanotubes Grown on λ-LiAlO₂ (100) Substrate by Metalorganic Chemical Vapor Deposition

Guoquiang Zhang, Masahiko Adachi, Sandip Ganjil, Atsushi Akamura, Jiro Temmoyo and Yoshio Matsui Photonic Devices Laboratory, Research Institute of Electronics, Shizuoka University, 3-5-1 Johoku, Hamamatsu 432-8011, Japan Advanced Materials Laboratory, National Institute for Materials Science, 1-1 Namiki, Tsukuba, Ibaraki 305-0044, Japan (Received May 22, 2007; accepted Jun. 10, 2007; published online Jul. 20, 2007)
©2007 The Japan Society of Applied Physics

### Synthesis and Characterization of Silver Filled Single-Wall Carbon Nanotubes

R. J. Kalenczuk, E. Borowiak-Palen, M. H. Ruemmeli, T. Gemming and T. Pichler Department of Hydrogen Technologies and Nanomaterials, Institute of Chemical and Environment Engineering, Szczecin University of Technology, 70-322 Szczecin, Poland Leibniz Institute for Solid State and Materials Research Dresden, Dresden, Germany Received: Nov. 12, 2005
©2006 Advanced Study Center Co. Ltd.

### Improved Charge Transfer at Carbon Nanotube Electrodes

Pichumani J. Britto, Kalathur S. V. Santhanam, Angel Rubio, Julio A. Alonso and Pulickel M. Ajayan Advanced Materials 1999, 11, No. 2
©1999 WILEY-VCH Verlag GmbH, D-69469 Weinheim, 1999

### Improved Oxygen Reduction Activity on Pt3Ni(111) via Increased Surface Site Availability

Vojislav R. Stamenkovic, Ben Fowler, Bongjin Simon Mun, Guofeng Wang, Philip N. Ross, Christopher A. Lucas, Nenad M. MarkovićScience 315, 493 (26 Jan. 2007)
©2007 American Association for the Advancement of Science
   Decoration of Activated Carbon Nanotubes with Copper and Nickel
L. M. Ang, T. S. A. Hort, G. Q. Xu, C. H. Tung, S. P. Zhao, J. L. S. Wang Department of Chemistry, National University of Singapore, Singapore, 119260 Institute of Microelectronics, Singapore Science Park, Singapore 117685
Carbon ISSN 0008-6223, 2000, vol. 38, No. 3, pp. 363-372
©2007 INIST-CNRS, Cote INIST: 11401
   Preparation of Glass Carbon Electrode Modified with Nanocrystalline Nickel-Decorated Carbon Nanotubes and Electrocatalytic Oxidation of Methanol in Alkaline Solution
Hongyan Xu, Huaquiang Wu, Dongmei Xu and Qianyi Wang College of Chemistry and Materials Science, Anhui Normal University, 241000, China Translated from Chinese Journal of Applied Chemistry, 2007, 24 (5): 503-506
Published online 7 Mar. 2008

### Polymer-Filled Nanoporous Membranes

Sunil Raghav A Thesis Submitted to the Faculty of Drexel University in Partial Fulfillment of the Requirements for the Degree of Master of Science in Chemical Engineering
© Copyright 2005 Sunil Raghav.

### BRIEF SUMMARY OF THE INVENTION

The fuel cell design I introduce here addresses the major problems mentioned above. While it maintains the essential structure of two electrodes and an electrolyte core, it is actually a large silicon diode employing a p-type impermeable silicon layer as the cathode and an n-type porous silicon layer as the anode, each infused with a matrix of nickel-decorated, sulfonic acid-filled silicon nanotubes. The electrodes are separated not by a flexible Nafion membrane but rather by a layered silica electrolyte composed of thousands of thin layers of silica film etched with horizontal micro channels and lined with proton-conducting sulfonic acid groups in a retaining solution. The silicon nanotubes are also filled with proton conducting material in the form of sulfonated polystyrene, after the work by Raghav (2005).

In this design, hydrogen travels not by diffusion through the electrode material, but rather by fast transport through the cathode nanotubes, which because of their structure can give the electrode an effective reaction surface area of 1000 square meters/cm². Electrons are stripped off the hydrogen inside the cathode nanotubes and travel outward through the catalytic layers of the nanotubes while the protons are transported internally by the sulfonic acid groups toward the silica electrolyte layer by electrophorectic attraction and gated feedback.

The silica composite layer is able to conduct the protons through its micro channels toward the anode with some level of control due to its ability to act as a voltage-controlled field effect gate. The anode receives the protons where they are filtered outward to the outside surfaces of the anodic nanotubes where a highly efficient oxygen reduction reaction takes place. The anode layer is porous and allows oxygen to diffuse toward the nanotube outer surfaces while the protons filter outward. Oxygen reduction of hydrogen takes place on the nickel-decorated nanotube surfaces completing the electrical circuit. Water and heat are channeled out from the reaction sites by a low-pressure vacuum pump and water vapor is recycled as needed.

The entire structure acts both like a fuel cell and like a diode. In this case the positive charge moves toward the anode, unlike in an actual diode where the negative charge moves toward the cathode.

### BRIEF DESCRIPTION OF THE SEVERAL VIEWS OF THE DRAWING

The several drawings included in this application include:

FIG. 1 shows a close-up view of a single silica film layer section. Page 13.

FIG. 2 shows a 3-D view of a silica electrolyte membrane functional strip and an exploded view of a group of films layered to form a composite membrane. Page 14.

FIG. 3 shows a side view of a composite silica electrolyte layer. Page 15.

FIG. 4 shows catalytic nickel being laid down on the channels of a silica composite electrolyte section. Page 16.

FIG. 5 shows fully-grown nanotubes on the surfaces of the electrolyte. Page 17.

FIG. 6 shows a 3-D view of a fuel cell assembly with nanotubes grown out of the electrolyte surfaces. Page 18.

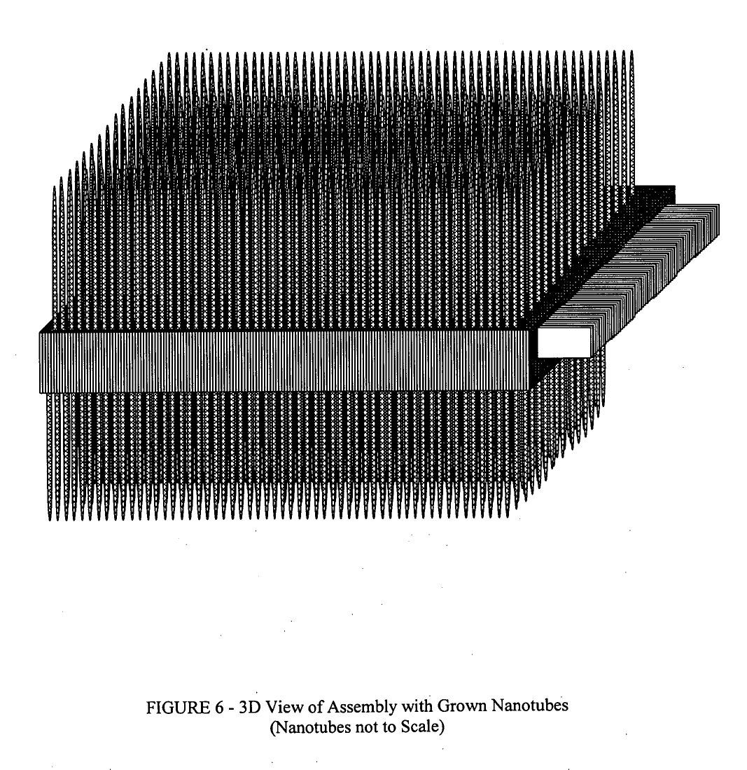

FIG. 7 shows the fuel cell assembly with layers of insulator applied over electrolyte surfaces. Page 19.

FIG. 8 shows the assembly with nanotubes decorated with nickel atoms. Page 20.

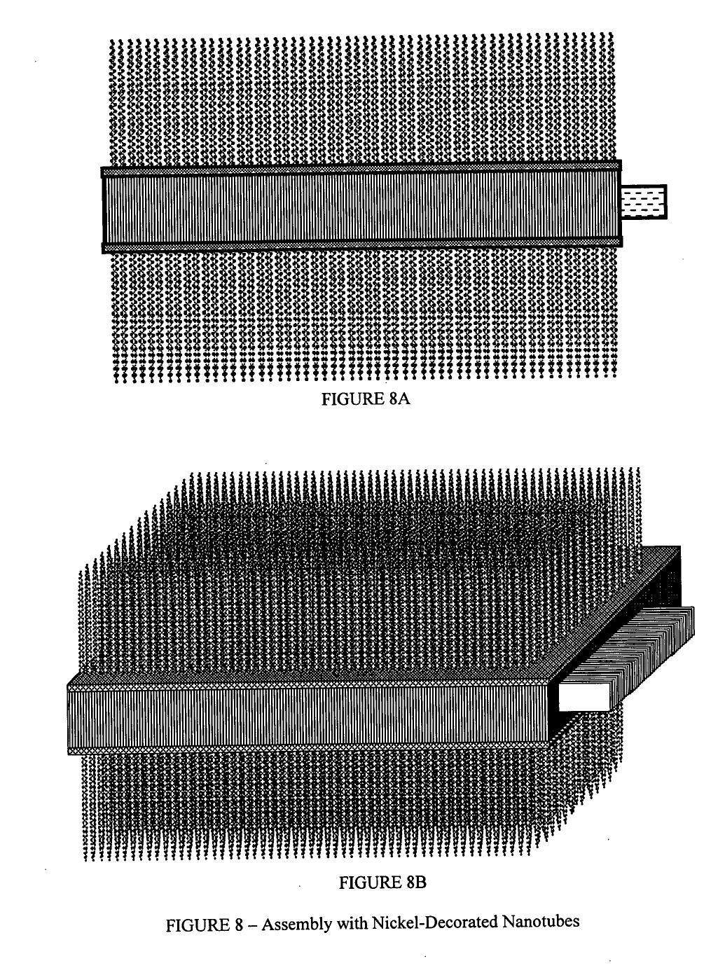

FIG. 9 shows the assembly with the cathode and anode layers deposited encapsulating the nanotube matrices. Page 21.

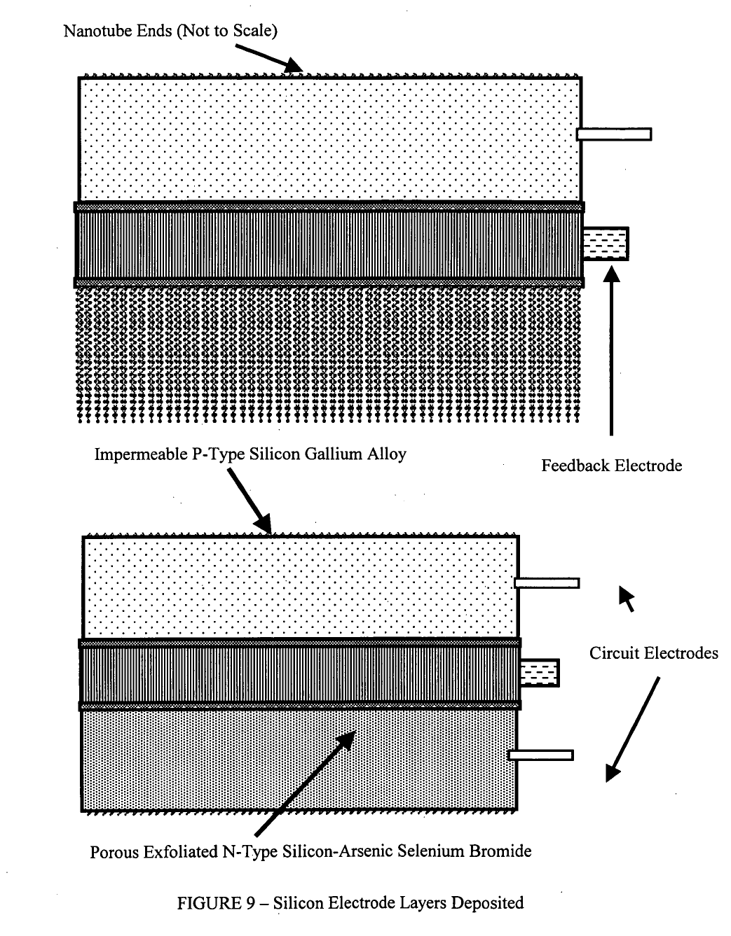

FIG. 10 shows the assembly with nanotubes opened up on the cathode side. Page 22.

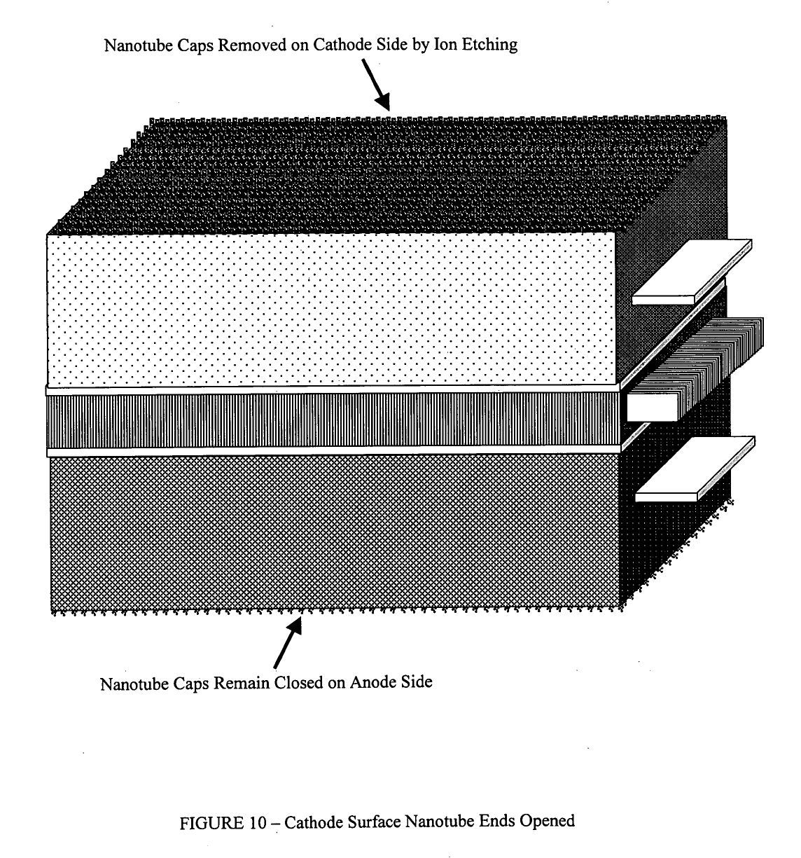

FIG. 11 shows the assembly immersed in a sulfonated polystyrene/acetone solution and the acid being infused into the structure. Page 23.

FIG. 12 shows a working unit of the fuel cell fully infused with sulfonic acid groups and water. Page 24.

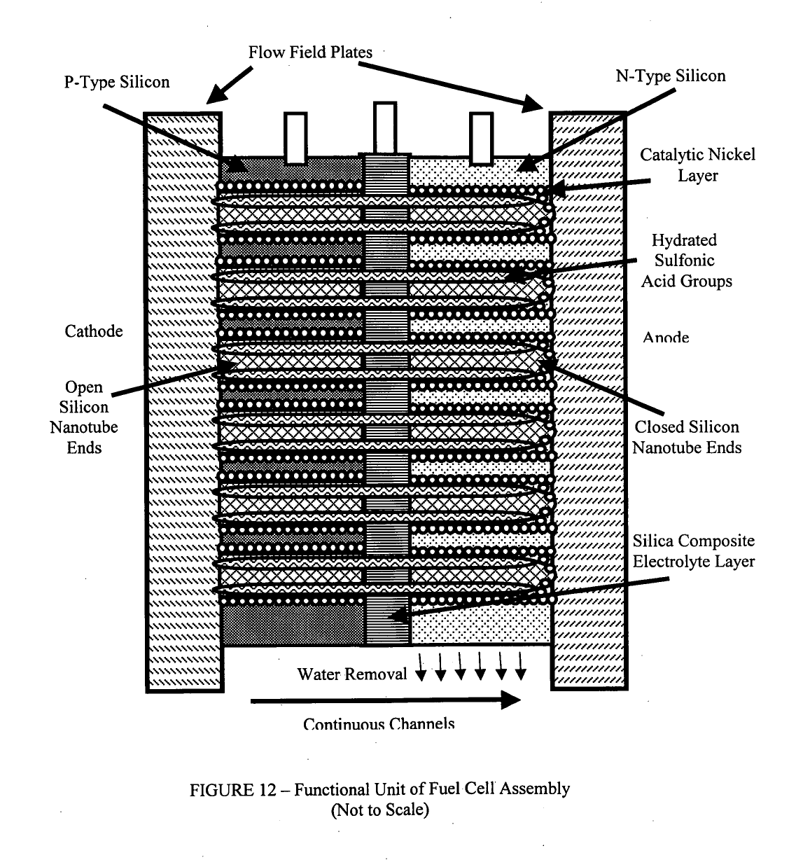

FIG. 13 shows a functional flow diagram of a fuel cell section. Page 25.

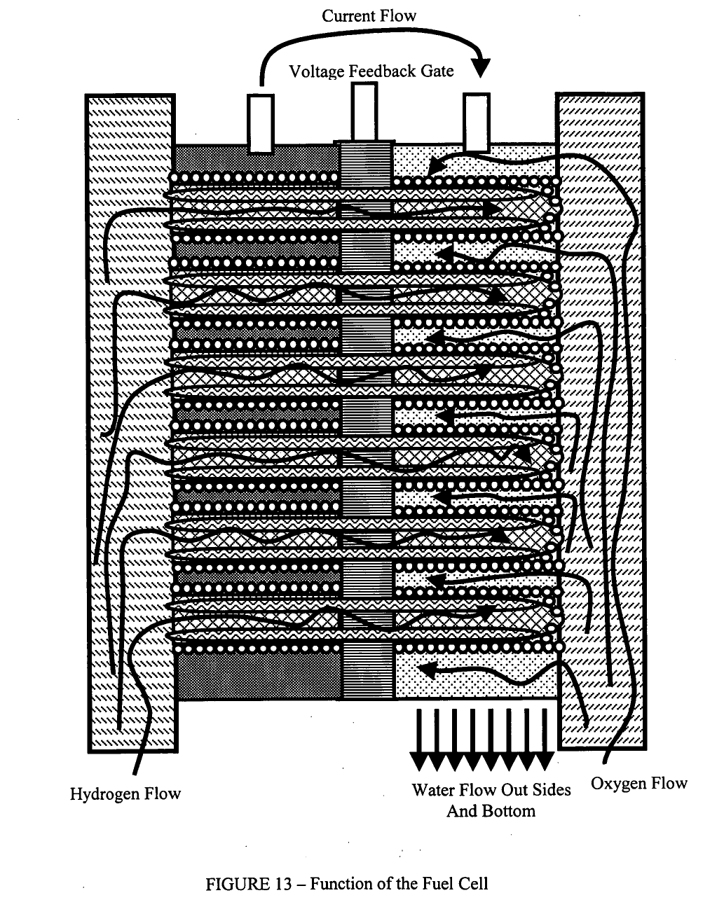

FIG. 14 shows a fully assembled and sealed fuel cell unit. Page 26.

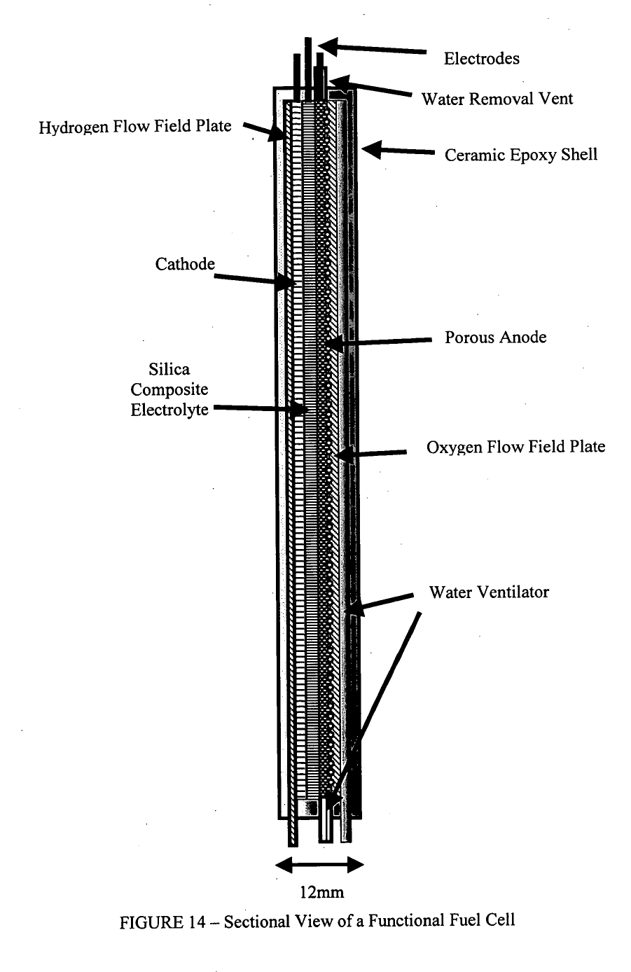

FIG. 15 shows a cut sectional view and a closed frontal view of a fuel cell unit. It also shows a typical stack of assembled fuel cell units. Page 27.

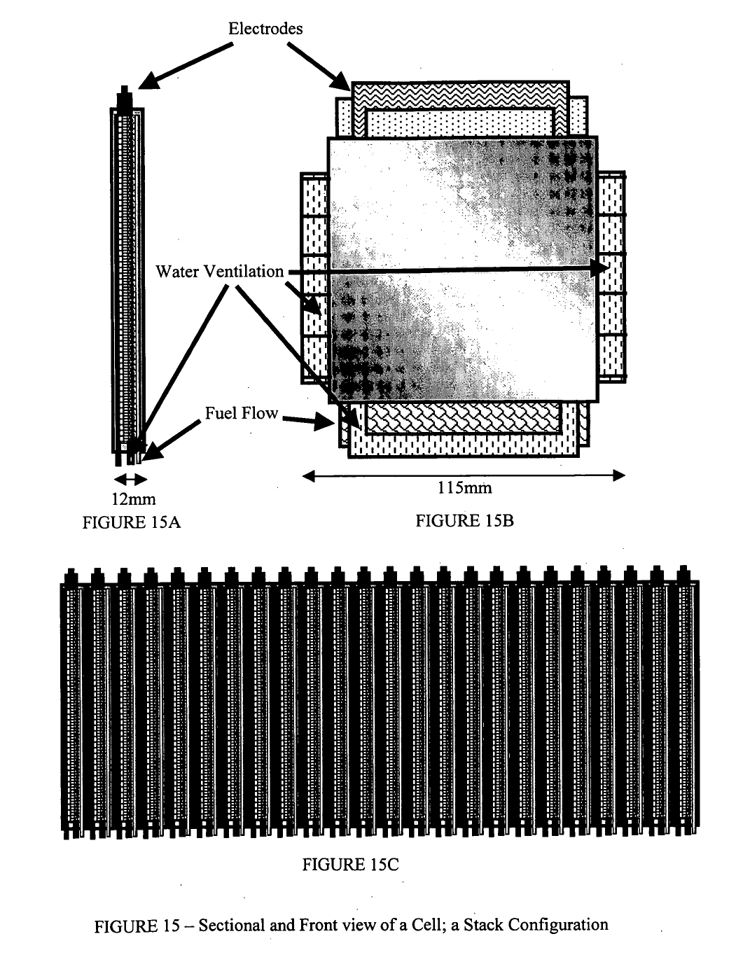

### DETAILED DESCRIPTION OF THE INVENTION

A proposal is made here for a new type of hydrogen-oxygen fuel cell composed of a semiconductor cathode electrode and a semiconductor anode electrode, each composed of a silicon nanotube matrix embedded in silicon and the electrodes separated by a micro channeled silica electrolyte composite layer with feedback regulation of the fuel flow.

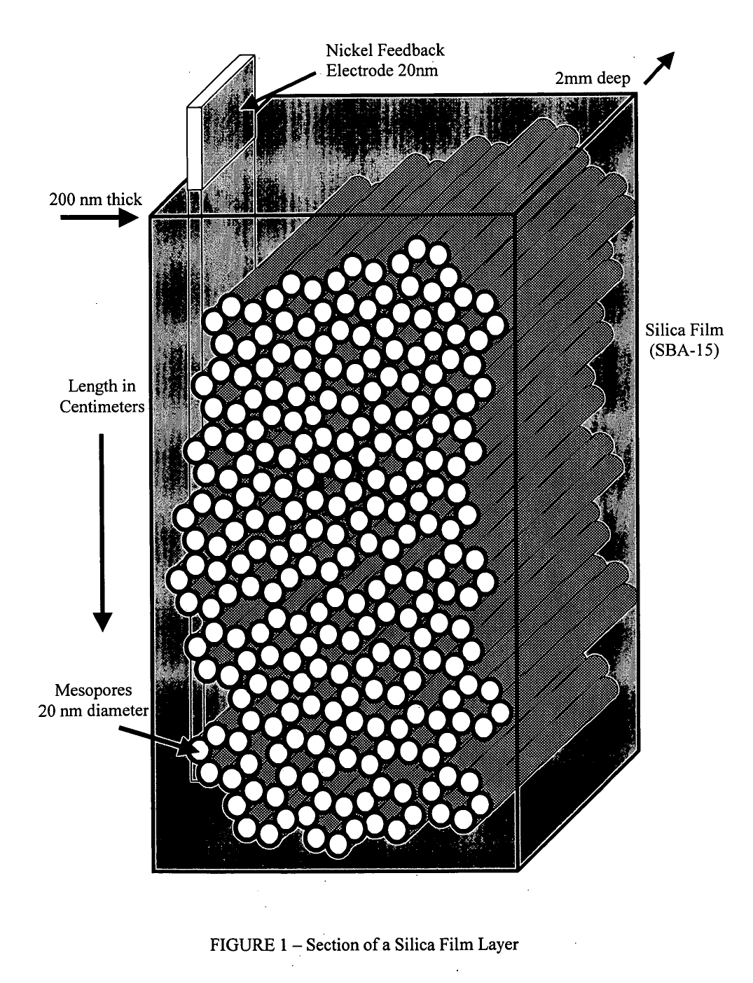

The heart of the device is a silica electrolyte composed of individual silica layers each with a thickness of 200 nm and a depth of 2 mm. Each thin film (SBA-15) is synthesized by the block-polymer-template sol-gel process outlined by Fan, Huh, et al., (2008) as described in their paper. Each silica layer is infused with a lattice of continuous mesochannels, each of no less than 20 nm in diameter and packed in regular hexagonal arrays and running parallel to the film surface. See FIG. 1.

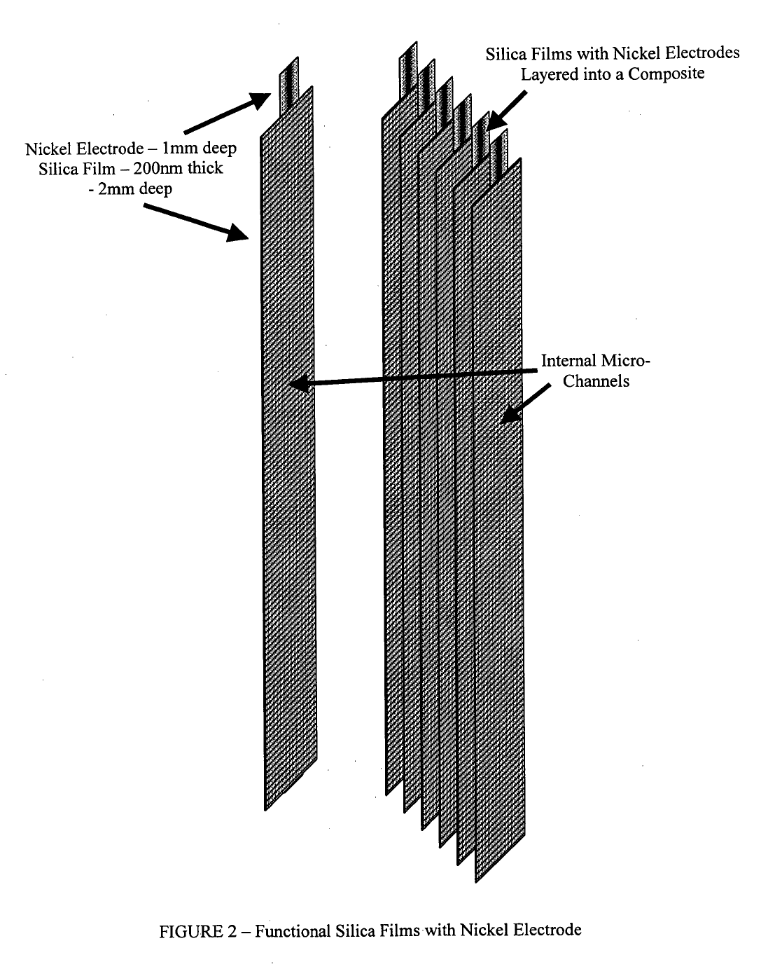

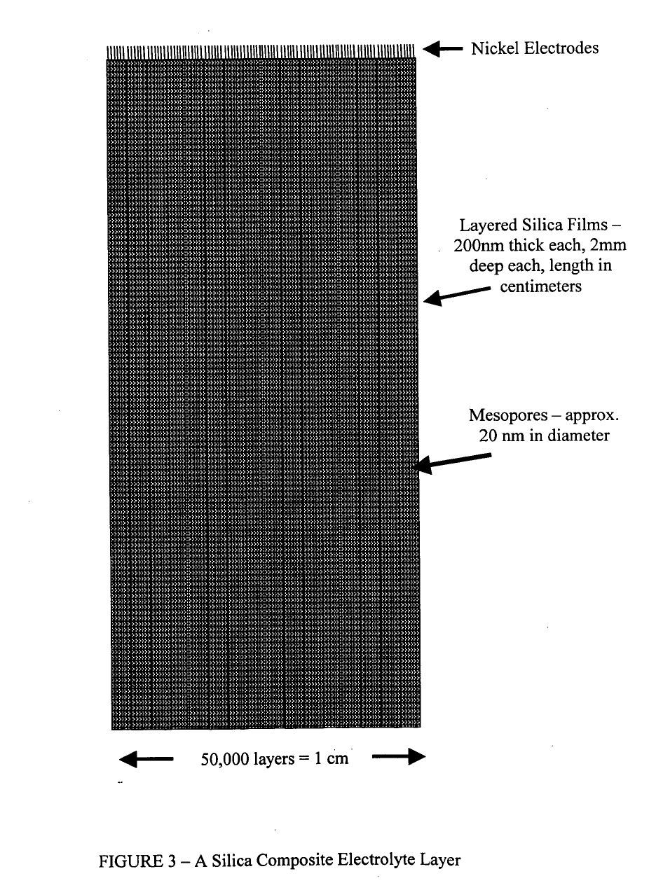

As each silica layer is built up, it is layered along its length with an embedded nickel electrode 20 nm thick and 1 mm in width and running the entire length of the layer. The electrode protrudes beyond the edge of the silica layer on the top. These electrodes are the gate control contacts. The silica layers and their electrodes are built one upon another until the desired width is achieved for the designated fuel cell application. See FIG. 2. This width will typically be measured in centimeters. A one-centimeter electrolyte layer will have 50,000 individual silica layers in its composition. The length of the silica composite also will be determined by the individual fuel cell size, typically also in centimeters. See FIG. 3.

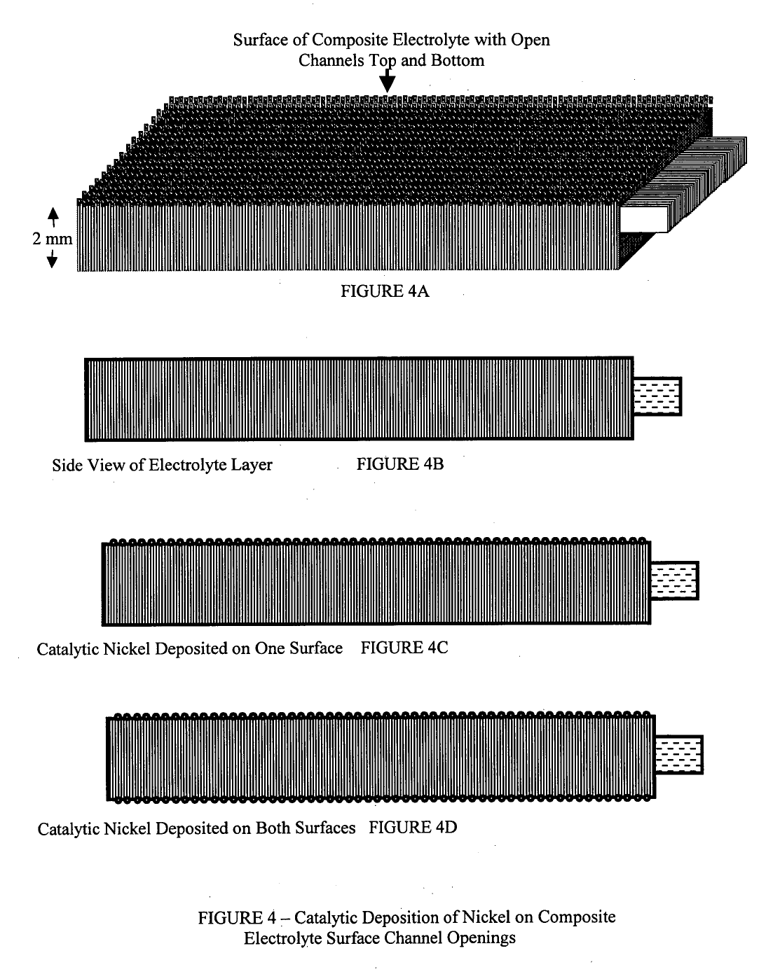

The resulting assembly will be a silica electrolyte composite layer infused with a continuous array of nano-channels each approximately 20 nm in diameter running the entire depth of the electrolyte. These are the transport channels for the hydrogen ions that will pass from the cathode to the anode while electrically insulating the two electrodes. As seen in the work of Fan, et al., proton transport through theses channels can be modulated with a gate voltage, allowing for feedback control in this design via the nickel electrodes. See FIG. 4A.

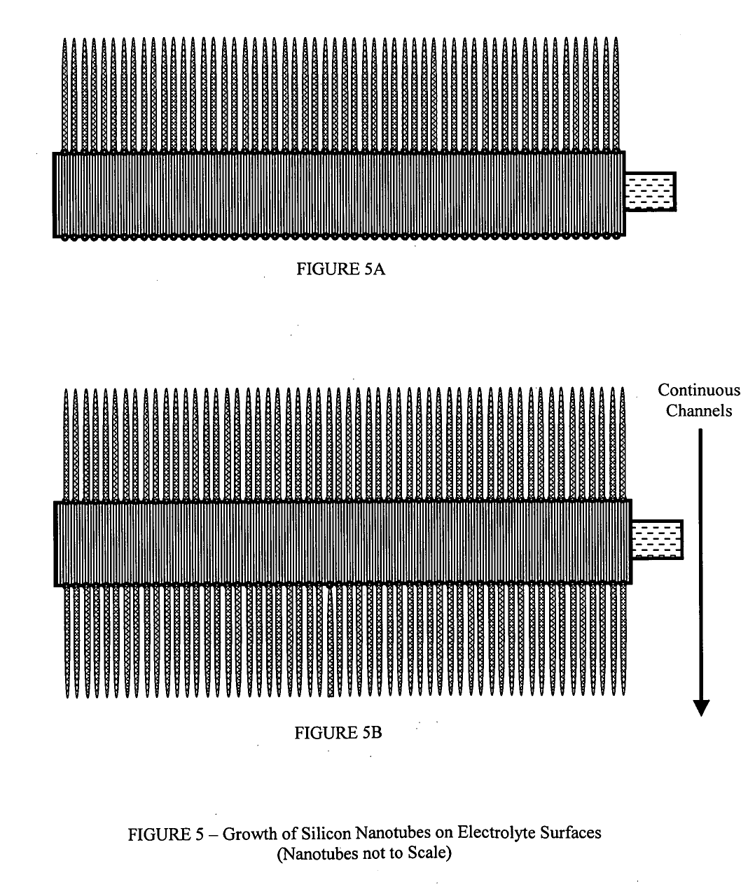

The completed silica electrolyte composite assembly then becomes the template for building the electrode layers (FIG. 4B). This is accomplished by catalytic chemical vapor deposition after the process developed by Holt et al. (2006), and also Lan et al., as seen in the referenced papers. The rim edges of the mesochannels top (FIG. 4C) and bottom (FIG. 4D) are deposited with a ring of molecular nickel and a matrix of single-walled, well-aligned silicon nanotubes are grown up from the edges of the silica mesopores. See FIG. 5A. These nanotubes are to be very long relative to their diameter, approximately 1 to 2 mm in length. The tubes are allowed to grow imperfectly, with bond-rotation defects, as sites where hydrogen oxidation and oxygen reduction will preferentially take place on the surfaces of the nanotubes, after the work by Britto et al. (1999). The silicon single-walled nanotubes are grown to their desired length and are allowed to form end caps. The nanotube layers are then treated with an acid bath of less than 2M HNO³ and washed with distilled water to purify them, after the process employed by Kalenczuk et al. This step will remove impurities from the matrix but NOT open the tube ends yet. See FIG. 5B.

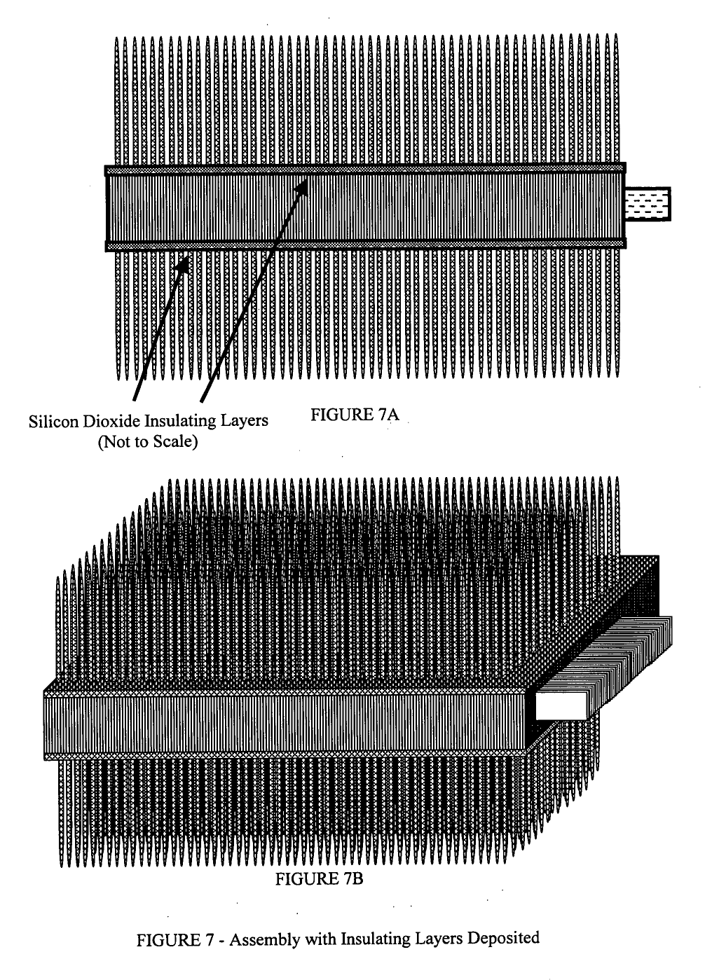

Next, the nanotubes are decorated with crystalline nickel by wet chemistry, after the work done by Xu et al. (2008) and L. M. Ang et al. (2000). Layered nickel has been shown to enhance surface catalytic activity for platinum after the work of Stamenkovic et al. (2007). This crucial step adds nickel as the metal catalyst replacing platinum while enhancing the electron absorbing ability of the silicon nanotubes. The surfaces of the silica electrolyte layer top and bottom are then coated with insulating silicon dioxide by chemical vapor deposition. See FIG. 7.

The final major step is to encapsulate the nanotube arrays in silicon. This is accomplished on the cathode side by a hard, low-pressure chemical vapor deposition of silicon and gallium to form the p-type silicon layer, again after the work of Hoyt et al. (2006). This is the electron-deficient layer, which enhances the electron-absorbing effects of the silicon nanotubes and the nickel catalyst layer when they act upon molecular hydrogen inside the nanotubes. The result is a gap-free membrane over the entire area of the nanotubes on the cathode side where the aim is to direct molecular hydrogen into the nanotube ends. The p-type silicon is deposited up to but not covering the nanotubes ends.

The anode side has a different structure and function. A low-pressure chemical vapor deposition process utilizing silicon and arsenic is used to form the n-type silicon layer. The anode side must be porous to allow oxygen to reach the nanotube surfaces, so selenium and bromide are added in the correct quantities to produce an exfoliated, n-type silicon electrode layer, after the work of D. D. L. Chung (1987) on carbon exfoliation. The n-type silicon is deposited up to but not covering the ends of the nickel-decorated nanotubes. The result is a porous, electron-rich semiconductor layer surrounding a matrix of nickel-decorated silicon nanotubes. In the fuel cell's ground state, the anodic silicon nanotubes and the nickel absorb electrons from the surrounding substrate, creating a depletion region similar to that found in a semiconductor diode. This causes the anode to take on a slightly positive charge, making it attractive to electrons introduced from an outside source. Concurrently, the nanotubes maintain a slightly negative charge, enhancing their attractiveness to hydrogen ions being transported across the electrolyte layer towards the anode nanotubes.

The encapsulation process results in a three-layered assembly of silicon and silica electrolyte. Excess silicon is removed from both surfaces by ion milling to expose the nanotube caps if needed. The nanotubes on the anode side will be left closed; the nanotubes on the cathode side will have their caps removed with reactive ion etching after the work of Hoyt et al. (2006).

In order for the device to reduce hydrogen and transport protons, there must be a proton exchange surface inside the nanotubes. The next step is to fill the nanotubes with hydrated sulfonic acid groups and bond them covalently to the nanotube inner surfaces where they will function as transport sites for hydrogen ions (protons) in a fashion similar to the action of Nafion.

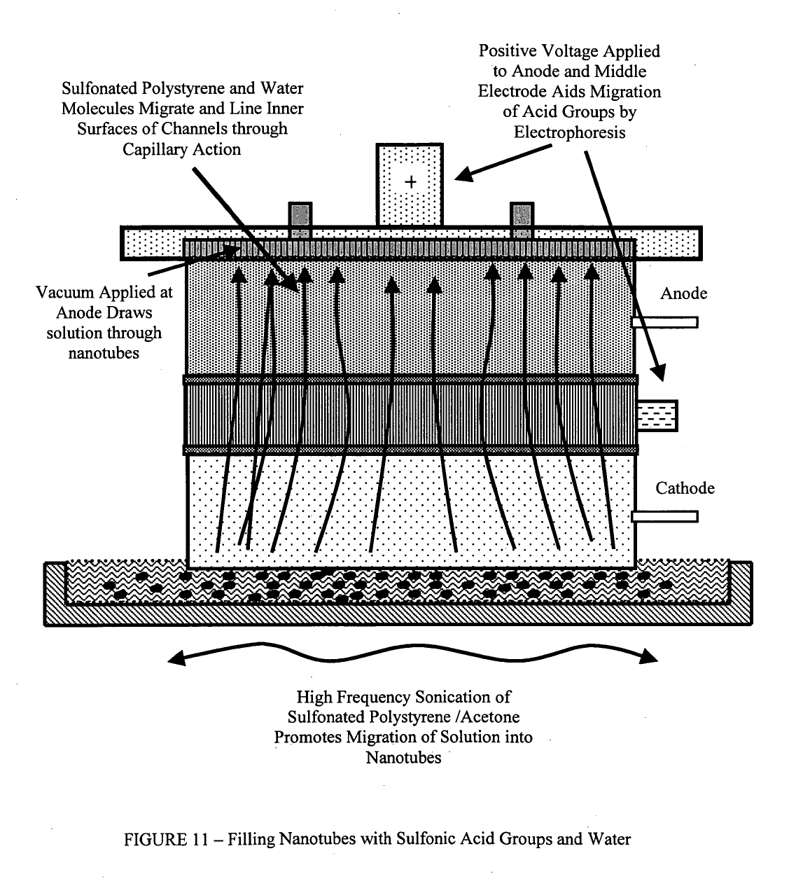

The cathode is immersed in 48% sulfonated polystyrene (SPS) dissolved in acetone 5% (w/v), after the work by S. Raghav. The solution is sonicated for at least 15 minutes, after the work by Kalenczuk et al. See FIG. 11. A vacuum pressure plate and a positive voltage are applied to the anode side. A positive voltage is applied to the middle electrode as well. The negative pressure combined with the voltage differential and capillary action will overcome any molecular resistance and reshape the SPS molecules, drawing them into the nanotubes all the way through the electrolyte layer and to the ends of the anodic nanotubes. The fuel cell assembly is then removed from the solution and subject to multiple centrifugations in distilled water to draw any unbonded sulfuric acid out of the nanotube matrices. The assembly is then dried in air at high temperature to seal the acid groups to the nanotube inner surfaces and to the outer edges of the nanotubes on the cathode surface side. The fuel cell will need to be hydrated upon initial use but should be able to maintain its hydration level with minimal intervention thereafter.

The entire assembly is now ready to be attached to flow field plates, which will direct fuel to the electrodes. The flow field plates are to be made of neutral silicon insulator (SO²) etched with patterned sub-millimeter channels to direct fuel flow evenly across the electrode surfaces. The flow field plates are attached by direct contact onto the cathode and anode surfaces and sealed around the sides with silicone and a precision ceramic gasket. The sides of the anode plate covering are etched with ventilation channels that direct water out the sides of the porous anode electrode by a low negative pressure pump. This can be an individual micro pump or a larger unit designed to handle multiple cells in a stack. Water vapor is ventilated out of the unit or redirected back toward the cathode as needed to keep the cell properly hydrated.

In a functioning diode fuel cell, hydrogen gas passes from the field flow plate to the cathode where it is attracted by the sulfonic acid groups within the nanotubes, aided by computer-controlled pressure pumps. The hydrogen is ionized within the tubes and the electrons pass out into the cathode, while the protons move toward the anode along the charge gradient created by the feedback electrodes within the silica electrolyte layer combined with the net negative charge of the anode. Oxygen introduced at the anode field flow plate diffuses through the porous anode and is attracted to the nickel-decorated nanotubes. The protons traveling through the silica electrolyte channels enter the nanotubes within the anode and diffuse outward, combining with the oxygen on the outside nanotubes surfaces. The hydrogen and oxygen are reduced to water with the supply of electrical charges that have passed from the cathode via an electrical path into the anode to complete the circuit. Waste heat is carried by the resultant byproduct water out the sides of the porous anode through the negatively pressurized exhaust vents.

1) This fuel cell design utilizes unique nanostructured electrodes to transport reactants by fast mass transport through nanotubes rather than by diffusion through a substrate. This design capitalizes on the very high reactant surface area existing inside nanotube structures for the transport, reduction and oxidation of fuel materials. It exploits the dominant surface behavioral dynamics that prevail inside nanotubes.

2) This design provides a method of producing platinum- and palladium-free electrodes for low-temperature fuel cells utilizing a unique triple catalytic action: a) the electron-absorbing characteristics of silicon nanotubes are exploited. b) Improved catalytic action due to nickel layering on nanotube surfaces is exploited. c) The electron-absorbing ability of p-type silicon and the electron donor capability of n-type silicon are utilized in the same manner as in a silicon diode.

3) This fuel cell design incorporates the active ingredients in proton-conducting Nafion but reorders them in such a way as to take advantage of the ability of nanotubes to be filled with and retain materials chemically. The proper term is ‘Ordered Ionic Nanostructures of Proton Transport Mechanism’, after S. Raghav (2005) referring to the linear arrangement of hydrated sulfonic acid groups inside the nanotubes surfaces.

4) This fuel cell design introduces a new type and model for a fuel cell electrolyte layer. Mesoporous silica films are layered into a composite electrolyte layer replacing Nafion as a standard design material for proton transport. The use of Gate Modulation as a feedback mechanism for controlling proton transport in a hydrogen fuel cell is implemented for the first time, leading to improved voltage and current stability.

5) This fuel cell design simplifies the hydration process and water management within the fuel cell enabling each fuel cell unit to be sealed permanently with minimal maintenance required. Hydrogen ions diffuse to the outside surfaces of the anodic nanotubes where oxygen reduction takes place. Oxygen and water cannot enter into the nanotubes, thus preventing oxygen contamination of the cathode as well as preventing water backflow to slow the cell reaction. Water is drawn away from the reaction sites by low-pressure negative exhaust channels on the outside surfaces of the porous anode. The disadvantages of Nafion, namely its limited reactant surface area, hydration problems, and physical interface problems due to its variable size are reduced or eliminated.
